(19) United States
(12) Patent Application Publication
(10) Pub. No.: US 2023/0055899 A1
(43) Pub. Date: Feb. 23, 2023

(54) Terrarium Lid Spacer

(71) Applicant: Theoden Gimli Parker, Hemet, CA (US)

(72) Inventor: Theoden Gimli Parker, Hemet, CA (US)

(21) Appl. No.: 17/746,540

(22) Filed: May 17, 2022

Related U.S. Application Data
(60) Provisional application No. 63/234,410, filed on Aug. 18, 2021.

(51) Int. Cl. A01K 63/00

(52) U.S. Cl. CPC A01K 63/006

(57) ABSTRACT

Improvements in a space for a terrarium or clone propagation enclosure that allows for displacement to provide even horizontal air flow between the lid and the propagation enclosure. The spaces are configured for installation on the top corners of the enclosure and creates an intermediate environment. With the installation of the spacer(s), the plants are provided with an initial exposure to the future growth environment when the dome is removed to improve adaptation to the drier, more windy conditions, causing them little to no stress when the dome is removed. The spacers can be stacked to increase the air gap between the lid and the enclosure. The lid spacers fit within the lid to retain the lid and minimize side-to-side movement. It also allows for a more stable structure if multiple stacked growing chambers are transported or used with the spacers installed.

### CROSS REFERENCE TO RELATED APPLICATION

This application claims the benefit of Provisional Application Serial Number 63/234,410 filed Aug. 18, 2021, the entire contents of which is hereby expressly incorporated by reference herein.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC

Not Applicable

### BACKGROUND OF THE INVENTION

### Field of the Invention

This invention relates to improvements in plant propagation within a terrarium. More particularly, the present terrarium lid spacer provides controlled humidity and air flow through a terrarium lid so plants within the terrarium propagate evenly.

### Description of Related Art Including Information Disclosed Under 37 CFR 1.97 and 1.98

Nursery propagation domes are great at holding in humidity to give cuttings the best environment to generate roots, but that same humidity causes mold and mildew issues after the initial phase of propagation. As the cuttings adapt and begin to produce roots, they require less and less humidity. Most propagation domes have some form of venting, but they are always on the top and don’t let air circulate through the cuttings very well. Taking the dome off shocks the clones because they do not have a proper chance to acclimate to the drier, windier room environment. Some growers slide the dome to the side to let air into the growing chamber, but this method is not effective and detrimental to the clones that get encroached adjacent to the opening.

A number of patents and or publications have been made to address these issues. Exemplary examples of patents and or publication that try to address this /these problem(s) are identified and discussed below.

U.S. Pat. No. 4,576,115 issued on Mar. 18, 1986 to Richard A, Gordon and is titled Tank Cover. This patent discloses a cover for an animal tank, fish tank or the like having an open top, and peripheral side portions having an exterior peripheral lip. The cover is formed of a flat screen attached to a continuous frame, which is provided with a plurality of resilient depending tabs having inwardly directed flanges which are adapted to engage beneath the lip of the tank, and are biased into engagement with the side portion of the top of the tank to lock the flange and lip together and secure the cover on the tank. While this patent includes a vented cover, the top of the cover is vented and does not allow for air flow across the top of the tank.

U.S. Pat. No. 6,581,327 issued on Jun. 24, 2003, to Jeffrey W. Adelberg et al., and is titled Apparatus and method for Propagating Plants. This patent discloses plant propagation apparatus is disclosed which comprises a flexible transparent enclosure. The enclosure is disposable, and could be formed of a polymer such as polyethylene. The enclosure would have at least two walls, formed of flexible material that facilitates transmission of light through the walls. Plant material is sealed within the enclosure, and nutrient solution is made available within the sealed enclosure for the plant. While this patent discloses plant propagation with vents, the propagation is within a bag.

U.S. Publication Number 20160165821 was published on Jun. 16, 2016 to Hitomitsu Fujiyama et al., and is titled Plant Cultivation Device, Box, End Section Unit. This publication discloses a plant cultivation device includes a plurality of boxes, a connection unit, and an end section unit. Each box is provided in an inner space thereof with a cultivation chamber and a light source housing chamber. The plurality of boxes is arranged in a line. The connection unit mutually connects two adjacent boxes. The end section unit is mounted to an end section of a box which is arranged in an end of the line. The end section of the box is unconnected to the connection unit. Each box includes a ventilation opening for ventilating the cultivation chamber, and a ventilation port for air cooling the light source housing chamber. While this publication provides air flow ventilation, the ventilation is with air through forced vent holes and not from an elevated lid.

What is needed is a spacer that allows for elevating the lid of a nursery propagation dome to allow for even horizontal air flow through the growing chamber. The terrarium lid spacer disclosed in this document provides the solution.

### BRIEF SUMMARY OF THE INVENTION

It is an object of the terrarium lid spacer that evenly elevates the cover or dome. Evenly displacing the cover or dome allows for even airflow through and across the upper portion of the dome or cove. This allows all seedlings or clones to receive an even amount of airflow so all of the seedlings or clones grow at an even rate and are ready for transplanting the maturing clones or seedlings.

It is an object of the terrarium lid spacer to be stackable to allow for a variable amount of ventilation. Depending upon the amount of air flow through the growing chamber, the height of the growing chamber and the height of the growing seedling or clones, multiple spacers can be stacked on top of each other to increase the distance between the growing chamber and the cover or dome. As the clones or seedlings grow, it is possible to remove the cover or dome, stack additional spacers and re-install the dome or cover.

It is an object of the terrarium lid spacer to be retained on the upper lip of the terrarium or growing chamber. The lid spacer is configured to straddle over the upper lip of the growing chamber to self-center and self-retain the lid spacer on the side(s) of the growing chamber. The lid spacers are sized to create a slight “grip” to the growing chamber to reduce dislodging the spacers if the growing chamber is bumped or tipped.

It is an object of the terrarium lid spacer to be fit onto a corner to securely prevent the spacers from being easily displaced. Configuring and placing the lid spacer on the corner of the growing chamber provides a stable two-dimensional stability to the lid spacer and prevents the lid spacer from sliding off of the corner of the growing chamber.

It is another object of the terrarium lid spacer to fit within the cover or dome. Because the lid spacer is configured to fit within (or outside of) the lid, the lid is securely retained from side-to-side movement. This also allows for stacking of additional grow chambers and lids to allow for additional elevated use of a facility. It also allows for a more stable structure if multiple stacked growing chambers are transported with the spacers installed.

It is another object of the terrarium lid spacer to be reusable. The lid spaces can be re-used multiple times. While the spacers are described for use in all four corners of the lid or cover, they can be used as a single, double or triple spacer with different, tilted or less than optimal even air flow through the cover or dome.

It is still another object of the terrarium lid spacer to allow for easy removal of the cover or dome. The installation and removal of the lid or dome is not affected by installation of the lid spacers and provide essentially the same fit to the underlying growing chamber.

Various objects, features, aspects, and advantages of the present invention will become more apparent from the following detailed description of preferred embodiments of the invention, along with the accompanying drawings in which like numerals represent like components.

### BRIEF DESCRIPTION OF THE SEVERAL VIEWS OF THE DRAWING(S)

FIG. 1 shows a perspective view of a clone tray with a dome that is elevated on multiple terrarium lid spacers.

FIG. 2 shows an isometric view of the terrarium lid spacer.

FIG. 3 shows a top view of the terrarium lid spacer.

FIG. 4 shows a front view of the terrarium lid spacer.

FIG. 5 shows a sectional view of the terrarium lid spacer.

FIG. 6 shows a sectional view of three stacked terrarium lid spacer.

### DETAILED DESCRIPTION OF THE INVENTION

It will be readily understood that the components of the present invention, as generally described and illustrated in the drawings herein, could be arranged and designed in a wide variety of different configurations. Thus, the following more detailed description of the embodiments of the system and method of the present invention, as represented in the drawings, is not intended to limit the scope of the invention, but is merely representative of various embodiments of the invention. The illustrated embodiments of the invention will be best understood by reference to the drawings, wherein like parts are designated by like numerals throughout.

While this technology is susceptible of embodiment in many different forms, there is shown in the drawings and will herein be described in detail several specific embodiments with the understanding that the present disclosure is to be considered as an exemplification of the principles of the technology and is not intended to limit the technology to the embodiments illustrated. The terminology used herein is for the purpose of describing particular embodiments only and is not intended to be limiting of the technology. As used herein, the singular forms “a,” “an,” and “the” are intended to include the plural forms as well, unless the context clearly indicates otherwise.

It will be further understood that the terms “comprises,” “comprising,” “includes,” and/or “including,” when used in this specification, specify the presence of stated features, integers, steps, operations, elements, and/or components, but do not preclude the presence or addition of one or more other features, integers, steps, operations, elements, components, and/or groups thereof. It will be understood that like or analogous elements and/or components, referred to herein, may be identified throughout the drawings with like reference characters.

### Item Numbers and Description

10 propagation dome 11 tray

12 lid 14 lower lip

15 upper lip 16 lid side wall

17 upper vents 20 terrarium lid spacer

21 back wall

22 front wall 23 back wall

24 front wall 30 head

31 outer wall radius 32 shoulder.

33 inner wall radius 34 saddle

35 top 40 indicia

90 flow through 92 height

93 upper head 94 saddle portion

95 corner gap 96 width

97 gap 98 air flow

99 air gap 100 void.

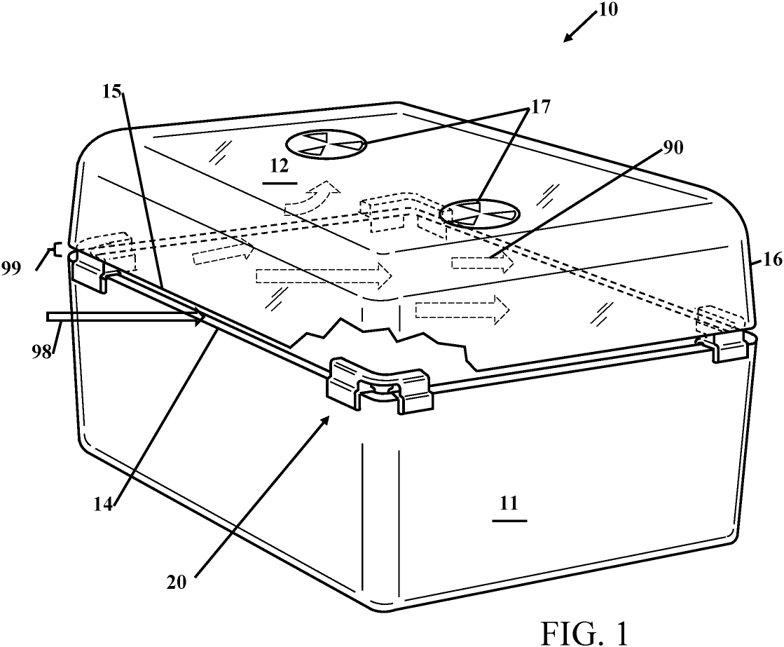

FIG. 1 shows a perspective view of a clone tray with a dome that is elevated air gap 99 on multiple terrarium lid spacers 20 placed on the corners of the growing chamber 10. The spacer(s) 20 fits onto the corners of a clone tray to support the propagation dome 12 above the tray 11, thereby creating an air gap 99. The air gap 99 allows air flow 98 into, flow through 90 and gently up through the clones and out the upper vents 17 and / or out the side of the growing chamber 10, creating an intermediate environment that affords the clones more acclimatization before the dome 12 is removed completely. The clones experience less shock, taking less time to become mature plants, saving vegetative time and energy. The air gap 99 is a minimum of 0.001 inches and is preferably between ⅛ inch and 1 inch.

### How the Terrarium Lid Spacer Works

One terrarium lid spacer 20 is placed on each of the four corners of the upper lip 14 of the clone tray 11. The spacers 20 can be stacked (shown and described in other figures) to create a larger gap for clones made from taller cuttings. The spacers 20 are designed so the side wall 16 of the lid 12 fits and sits on the lower lip 15 of the lid. The spacer 20 has a lower portion that simulates the lid lip 15 and an upper portion that simulates the upper lip 14 of the tray.

### How to Use the Terrarium Lid Spacer

As the cuttings develop roots, they no longer rely on their stems and leaves to hydrate, so dome vents 17 are slowly opened more and more each day until they are completely open. After the dome vents 17 have been fully opened for 24 hours, the spacers 20 are installed to create an air gap 99 between the tray 11 and propagation dome 12. With the dome vents 17 fully open, it is too humid and there is zero air movement inside the dome 12. The new clones aren’t prepared for a windier, drier environment and show signs of stress when the dome 12. is removed. After 48 hours of acclimatization, the propagation dome 12 can safely be removed, and the rooted clones are ready for transplant immediately. Using the spacer creates healthier, stronger clones.

While this figure shows four spacers 20 placed on all four corners, two or three spacers 20 could be used to support the dome 12. It is further contemplated that two spacers could be placed on one side to set the dome 12 at an angle, or a single spacer 20 could be used with diminished performance.

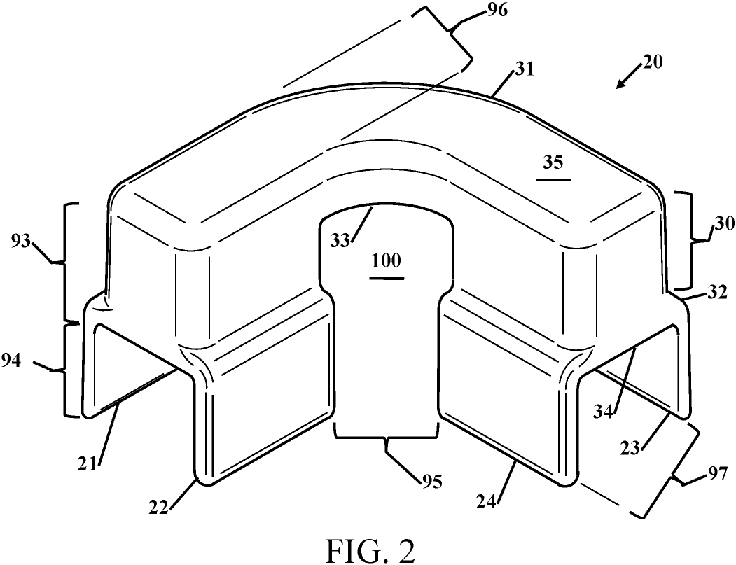

It is also contemplated that the spacer 20 could be designed to fit only along the elongated sides to space the dome 12, but this embodiment would result in a less stable spacer.

[ 53] FIG. 2 shows an isometric view of the terrarium lid spacer 20. This view is looking into the corner where the spacer 20 would bridge perpendicular sides of the propagation dome (not shown). The spacer 20 is configured to straddle the perpendicular walls of the tray where the walls of the tray (not shown) would pass through the gap(s) 97. The walls of the tray would be restrained between the back walls 21 / 23 and the front walls 22/ 24 of the spacer 20. The gap 97 between the front walls 22 / 24 and back walls 21 /23 provides a clearance or a slight interference fit to the tray walls. A slight interference fit helps retain the spacer 20 if the propagation dome is moved or bumped. Between the front walls 22 / 24 and the back walls 21 / 23 is a saddle 34 that is configured to rest on the top edge of tray (not shown). The edge of the tray will sit and be secured in the saddle portion 94 of the spacer 20. Above the saddle portion 94 is an upper head 93.

The upper head 93 has a head 30 that is shaped to approximate the upper edge of the tray. The head 30 allows the dome (not shown) to be elevated by approximately the height of the head 30 to allow air to flow into the propagation dome from any direction around the propagation dome. The top 35 has a width 96 that approximates the width of the tray. At a top 35 of the spacer 20 is a wall that connection and supports the perpendicular bridge sections with an outer radius 31 and an inner wall radius 33. A shoulder 32 provides a width transition between the saddle portion 94 and the upper head 93. At the perpendicular transition is a corner gap 95 with a void 100 that also allows for air passage. The void 100 extends from inside the spacer 20 to outside of the spacer 20.

The spacer 20 is preferably injection molded from plastic, but other materials and manufacturing methods are contemplated based upon manufacturing requirements and cost considerations.

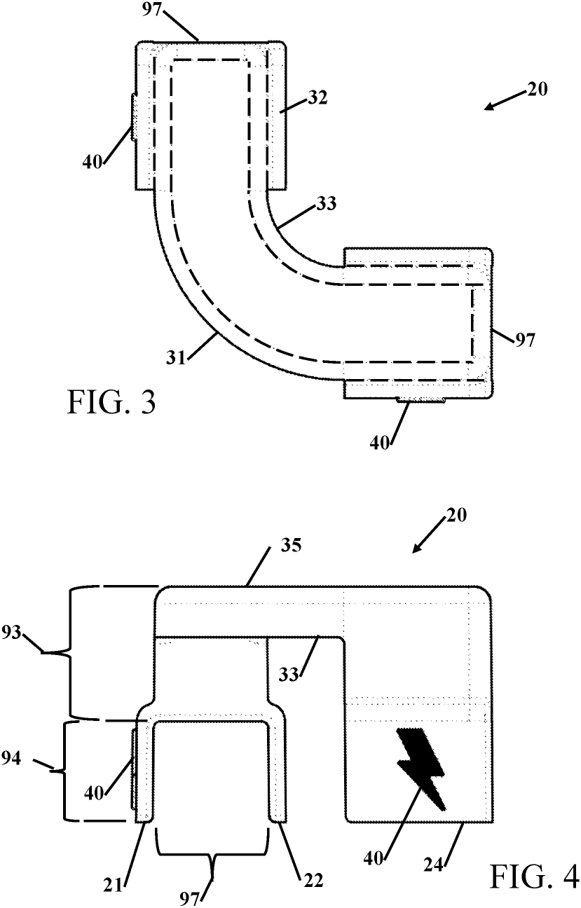

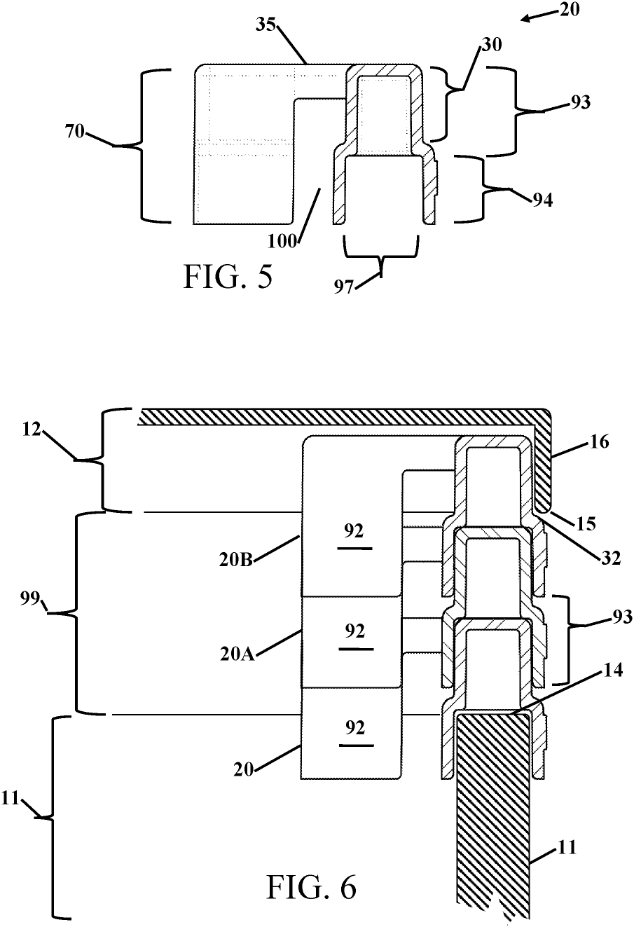

FIG. 3 shows a top view of the terrarium lid spacer 20, FIG. 4 shows a front view of the terrarium lid spacer 20 and FIG. 5 shows a sectional view of the terrarium lid spacer 20. These collective plan views and sectional view provides a between understanding of the construction of the spacer 20. From the top plan view, broken lines have been included to show the wall thicknesses. The shoulder 32 on the perpendicular arms extend outside of the inner wall radius 33 and the outside wall radius 31. This view also shows indicia 40 extending from the sides of the spacer 20. While some figures show a “lighting bolt” indicia, other shapes are contemplated based upon ownership or customization. The top plan view shows that the two perpendicular sides have gap(s) 97 where the walls of the tray (not shown) can pass and be stabilized by the two perpendicular walls of the tray.

Referring to the side and sectional views the gap 97 where the wall of the tray can pass between the back wall 21 and the front wall 22 / 24 is more visible. The bridge transition between the perpendicular walls is shown between the top 35 and the bottom of the inner wall radius 33. The void 100 or corner clearance is shown at the intersection of the perpendicular components or wings. The sectional view shows the overall height 92 of the spacer 20 along with the head 30 in the upper head 93 section above the saddle portion 94.

FIG. 6 shows a sectional view of three stacked terrarium lid spacer 20, 20A and 20B. Because the spacer(s) 20 are configured to approximate the upper lip 14 of the tray 11 and the lid 12 side wall 16 one or a plurality stack of spacer(s) 20 can be utilized to obtain the desired air between the tray 11 and the lid 12 with the outer upper lip 15 resting on the shoulder 32 of the uppermost spacer 20. Each spacer 20 provides an air gap of approximately the upper head 93, and this figure the air gap 99 is approximately 3 times the dimension of the upper head 93 that is less than the overall height 92 of each individual space 20.

While this figure shows three stacked spacers 20, there could as few as one spacer 20 to provide a gap for air flow to two spacers 20, three spacers 20 or more depending upon the user preference. After using the spacers 20 they can be reused, or removed and used on another propagation dome.

While the spacer 20 is shown for a rectangular tray with perpendicular wall, the spacer can be configured for radiused wall trays or round trays.

Thus, specific embodiments of a terrarium lid spacer have been disclosed. It should be apparent, however, to those skilled in the art that many more modifications besides those described are possible without departing from the inventive concepts herein. The inventive subject matter, therefore, is not to be restricted except in the spirit of the appended claims.

### SEQUENCE LISTING

Not Applicable.

1. A terrarium lid spacer comprising:
a perpendicular walled structure;
each side of the perpendicular walled structure having a front wall and a back wall connected by a saddle;
each front wall and back wall being spaced to accept a tray between said front wall, said back wall and said saddle therein between;
above said saddle is a head feature that connects each said perpendicular saddle;
said head feature being sized to approximate a dimension between said front wall and said back wall;
said head being sized to accept and support a lid on an outside of said head and above said saddle.

2. The terrarium lid spacer according to claim 1, that is configured to provide an air gap between said tray and said lid.

3. The terrarium lid spacer according to claim 1, wherein said perpendicular walled structure is configured to engage on a corner of said tray.

4. The terrarium lid spacer according to claim 1, is constructed from plastic.

5. The terrarium lid spacer according to claim 4, is injection molded.

6. The terrarium lid spacer according to claim 1, further includes at least one indicium.

7. The terrarium lid spacer according to claim 6, wherein said indicium is a lightning bolt.

8. The terrarium lid spacer according to claim 1, wherein a dimension between an inside of said front wall and said back wall provides an interference fit to said tray.

9. The terrarium lid spacer according to claim 1, further includes a corner opening between said perpendicular sections.

10. The terrarium lid spacer according to claim 9, wherein said corner opening allows for air flow through said perpendicular walled structure.

11. The terrarium lid spacer according to claim 1, further includes at least a second spacer stacked on top of said spacer.

12. The terrarium lid spacer according to claim 1, further includes four spacers, wherein each spacer is paced on a perpendicular corner of said tray.

13. The terrarium lid spacer according to claim 2, wherein said air gap is greater than 0.001 inches.

14. The terrarium lid spacer according to claim 2, wherein a single spacer creates and air gap of between ⅛ inch and 1 inch.

15. The terrarium lid spacer according to claim 1, further includes a shoulder above said saddle.

16. The terrarium lid spacer according to claim 15, wherein said shoulder is configured to support said lid.

17. The terrarium lid spacer according to claim 1, wherein said lid further includes at least one vent.

18. The terrarium lid spacer according to claim 17, provides air flow into said air gap and out of said at least one vent.

19. The terrarium lid spacer according to claim 1, wherein said tray provides a propagation chamber for growing clones.

20. The terrarium lid spacer according to claim 1, is configured to support said spacer on top of two perpendicular walls of said tray.
